(19) United States
(12) Patent Application Publication
(10) Pub. No.: US 2009/0072702 A1
(43) Pub. Date: Mar. 19, 2009

(54) PLASMA DISPLAY PANEL AND METHOD OF MANUFACTURING A DISCHARGE ELECTRODE SHEET USED THEREIN

(76) Inventors: Jae-Ik Kwon, Suwon-si (KR); Won-Ju Yi, Suwon-si (KR); Kyoung-Doo Kang, Suwon-si (KR); Seok-Gyun Woo, Suwon-si (KR)

Correspondence Address: CHRISTIE, PARKER & HALE, LLP, PO BOX 7068, PASADENA, CA, 91109-7068, US

(21) Appl. No.: 12/208,225

(22) Filed: Sep. 10, 2008

(30) Foreign Application Priority Data
Sep. 19, 2007 (KR) 10-2007-0095423

(51) Int. Cl. H01J 63/04; H01J 9/00

(52) U.S. Cl. 313/485; 445/1

(57) ABSTRACT

A plasma display panel includes a first substrate and a second substrate. The first and the second substrates are flexible and face each other. A discharge electrode sheet is disposed between the first and second substrates to configure a plurality of discharge cells and includes a plurality of patterned discharge electrodes. A phosphor layer is formed in each of the discharge cells. An exhaust gas pathway is formed in the discharge electrode sheet and connects the discharge cells. The exhaust gas pathway that connects adjacent discharge cells is formed in the film shape discharge electrode sheet between the first and second substrates.

### CROSS-REFERENCE TO RELATED PATENT APPLICATION

This application claims priority to and the benefit of Korean Patent Application No. 10-2007-0095423, filed on Sep. 19, 2007, in the Korean Intellectual Property Office, the entire content of which is incorporated herein by reference.

### BACKGROUND OF THE INVENTION

1. Field of the Invention

The present invention relates to a plasma display panel (PDP) and, more particularly, to a folding type PDP and a method of manufacturing a discharge electrode sheet for use in the PDP.

2. Description of the Related Art

A PDP is a flat panel display device that displays desired numbers, letters, or images using visible light emitted from phosphor layers excited by ultraviolet rays generated during a gas discharge initiated by applying a direct or alternate current voltage to a plurality of discharge electrodes formed on a plurality of substrates after a discharge gas is sealed between the plurality of substrates.

A typical PDP includes a plurality of substrates having a first substrate and a second substrate coupled to the first substrate, a chassis base attached to a rear of the substrate, and a driving circuit board attached to a rear of the chassis base.

A method of manufacturing a conventional PDP will now be briefly described.

In the case of the first substrate, a plurality of first discharge electrodes are formed on an upper surface of the first substrate, a first dielectric layer is printed on the first discharge electrodes to bury the discharge electrodes, and a protective film layer is formed on a surface of the first dielectric layer. In the case of the second substrate, a plurality of second discharge electrodes are formed on an upper surface of the second substrate, a second dielectric layer is printed on the second discharge electrodes to bury the second discharge electrodes, a barrier rib structure for defining discharge cells is formed on the second dielectric layer, and respective red, green, and blue phosphor layers are coated on inner walls of the barrier rib structure.

The first and second substrates formed through the above processes are sealed through an annealing process at a predetermined temperature by coating a glass frit on edges of inner surfaces facing each other in an arranged state. In order to remove moisture and impurity gases remaining in a space sealed between the first and second substrates, a process to remove gas is performed in a vacuum state. Afterwards, a discharge gas having Xe—Ne as a main component is injected into the space and sealed within it, and an aging discharge is performed by applying a predetermined voltage to the first and second discharge electrodes. Then, the manufacture of a plasma display panel is completed by mounting a signal transmission unit having IC chips on the chassis base.

However, in a conventional PDP, the substrates are transparent substrates formed of, for example, glass such as soda lime glass or PD-200. In this case, the substrates have a thickness of a few millimeters, and thus their weight increases. Accordingly, it is difficult to realize a lightweight plasma display panel and the plasma display panel is dimensionally limited. Accordingly, studies have been conducted to drive the plasma display panel structure in a different direction, such as in a foldable state or a rolled state.

Referring to FIG. 1, a conventional foldable PDP 100 includes a first flexible substrate 101, a second flexible substrate 102 facing the first flexible substrate 101, and a discharge electrode sheet 103 disposed between the first flexible substrate 101 and the second flexible substrate 102. A sealant 104 is interposed between the first flexible substrate 101 and the second flexible substrate 102 on both sides of the discharge electrode sheet 103.

In this case, however, when the space between the first flexible substrate 101 and the second flexible substrate 102 is vacuumed through an exhaust tube 105, unlike in the case of a thick glass substrates, the flexible first substrate 101 and the flexible second substrate 102 are pulled inside the discharge cells 106 due to pressure transmitted to the discharge cells 106 from the outside. Thus, moisture and impurity gases cannot be smoothly exhausted to the outside from regions A around the discharge cells 106.

### SUMMARY OF THE INVENTION

In accordance with the present invention, a PDP is provided wherein gas can be smoothly exhausted by forming an exhaust gas path in a discharge electrode sheet installed in a flexible film type substrate.

In addition, a method of manufacturing a discharge electrode sheet for use in the PDP is also provided.

In an exemplary embodiment of the present invention, a PDP includes a first substrate and a second substrate. The first and second substrates are flexible and face each other. A discharge electrode sheet is disposed between the first and second substrates to configure a plurality of discharge cells and includes a plurality of patterned discharge electrodes. A phosphor layer is formed in each of the discharge cells. A plurality of exhaust gas pathways are formed in the discharge electrode sheet, each exhaust gas pathway connecting a one of the discharge cells with an adjacent discharge cell.

The discharge electrode sheet may include a base film, patterned discharge electrodes formed on the base film, and a dielectric layer that buries the discharge electrodes.

Opening holes may be formed in portions of the discharge electrode sheet corresponding to the discharge cells through the discharge electrode sheet.

The discharge electrodes may include the first discharge electrode formed on a first surface of the base film and a second discharge electrode formed on a second surface of the base film.

Each of the first discharge electrode and the second discharge electrode may include a metal film layer formed on the base film and a plating layer formed on the metal film layer.

The exhaust gas pathways may be formed by forming predetermined grooves on a surface of the dielectric layer that contacts the first substrate or the second substrate and by connecting the adjacent discharge cells with the grooves.

The grooves may be formed between the discharge cells adjacent in a direction of the PDP and to connect the adjacent discharge cells by reducing the thickness of regions of the dielectric layer between the discharge cells to be smaller than other regions of the dielectric layer.

Phosphor layer grooves having a predetermined depth may be formed in an inner surface of regions of the first substrate or the second substrate corresponding to each of the discharge cells, and the phosphor layer may be formed in each of the phosphor layer grooves.

According to another exemplary embodiment of the present invention, there is provided a method of manufacturing a discharge electrode sheet. A raw material for forming the discharge electrode sheet is prepared. Plating holes are formed having a discharge electrode pattern by exposing and developing a photoresist after coating the photoresist on the raw material for forming the discharge electrode sheet. A plating layer is plated in the plating holes. The photoresist is removed. A discharge electrode pattern is formed by etching the plating layer. An exhaust gas pathway is formed by coating a dielectric layer on the raw material for forming the discharge electrode sheet to bury the discharge electrodes; Opening holes are formed that correspond to the discharge cells in the raw material for forming the discharge electrode sheet.

The preparing of a raw material for forming the discharge electrode sheet may include preparing a base film and attaching metal film layers onto both surfaces of the base film.

The plating of the plating layer may include plating a plating layer that electrically connects the metal film layer through the plating holes.

The forming of the exhaust gas pathway may include forming the exhaust gas pathway by connecting the adjacent discharge cells with the grooves after forming predetermined grooves by reducing the thickness of the dielectric layer between adjacent discharge cells.

### BRIEF DESCRIPTION OF THE DRAWINGS

FIG. 1 is a cross-sectional view showing a gas exhaust state of a conventional PDP.

FIG. 2 is a cutaway exploded perspective view of a PDP according to an embodiment of the present invention.

FIG. 3 is a cross-sectional view taken along line III-III of FIG. 2.

FIG. 4 is an exploded perspective view of a discharge electrode of FIG. 2.

FIG. 5 is a cross-sectional view of the PDP of FIG. 2, from which gases are exhausted.

FIG. 6 is a plan view of an exhaust gas pathway of the PDP of FIG. 2.

FIG. 7A is a cross-sectional view illustrating a state in which a raw material for forming the discharge electrode sheet according to an embodiment of the present invention is prepared.

FIG. 7B is a cross-sectional view illustrating a state in which a photoresist is coated on the raw material for forming the discharge electrode sheet of FIG. 7A.

FIG. 7C is a cross-sectional view illustrating a state in which the photoresist of FIG. 7B is exposed.

FIG. 7D is a cross-sectional view illustrating a state in which the photoresist of FIG. 7C is developed.

FIG. 7E is a cross-sectional view illustrating a state in which the raw material for forming the discharge electrode sheet of FIG. 7D is plated.

FIG. 7F is a cross-sectional view illustrating a state in which the discharge electrode of FIG. 7E is patterned.

FIG. 7G is a cross-sectional view illustrating a state in which the manufacture of discharge electrode of FIG. 7F is completed.

FIG. 7H is a cross-sectional view illustrating a state in which a dielectric layer is coated on the discharge electrode of FIG. 7G.

FIG. 7I is a cross-sectional view illustrating a state in which discharge cells are formed in the discharge electrode sheet of FIG. 7H.

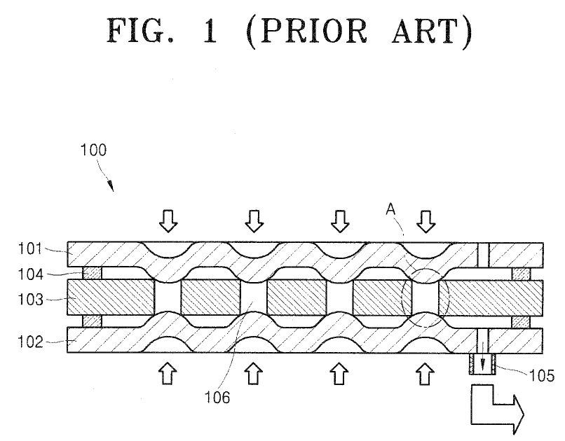

### DETAILED DESCRIPTION

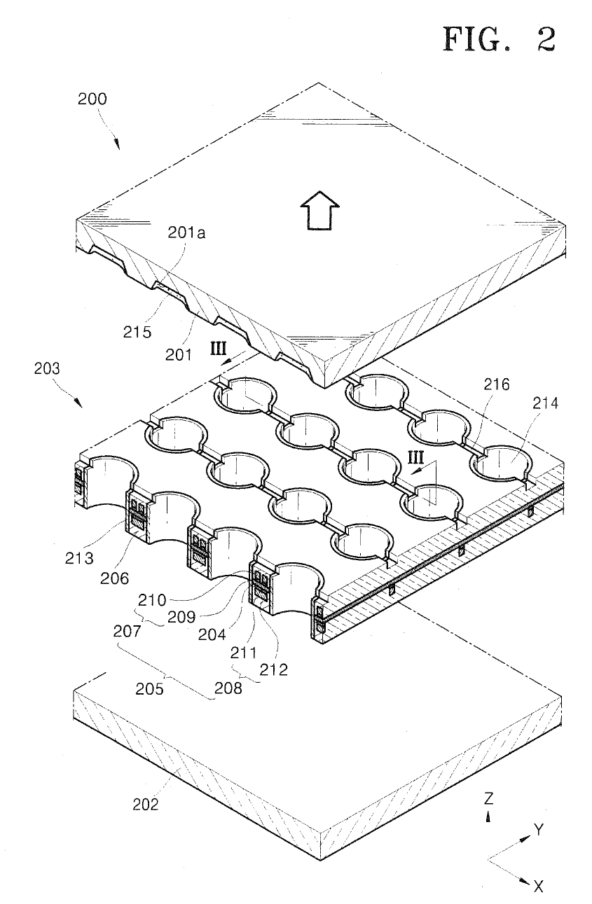

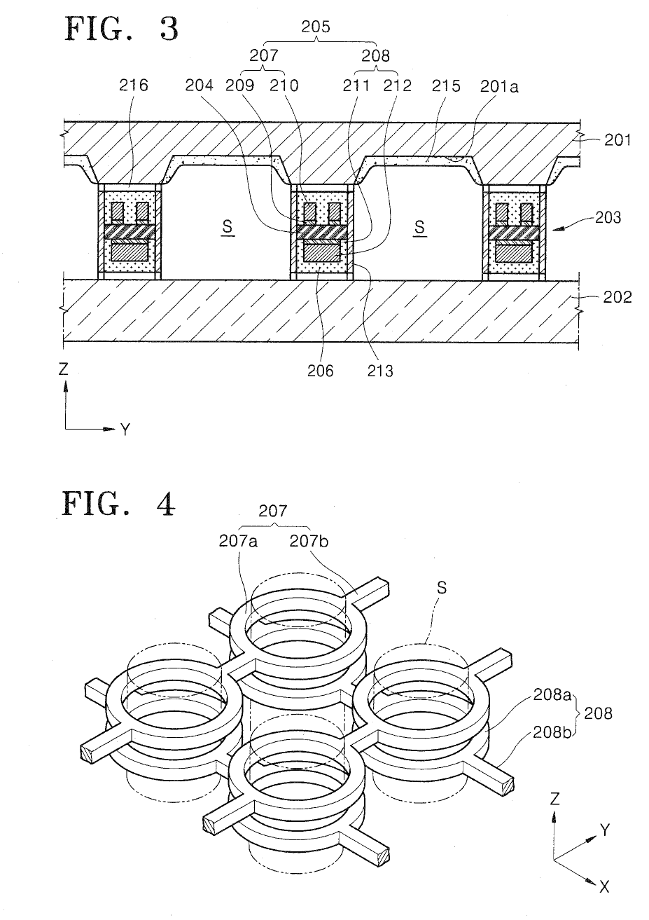

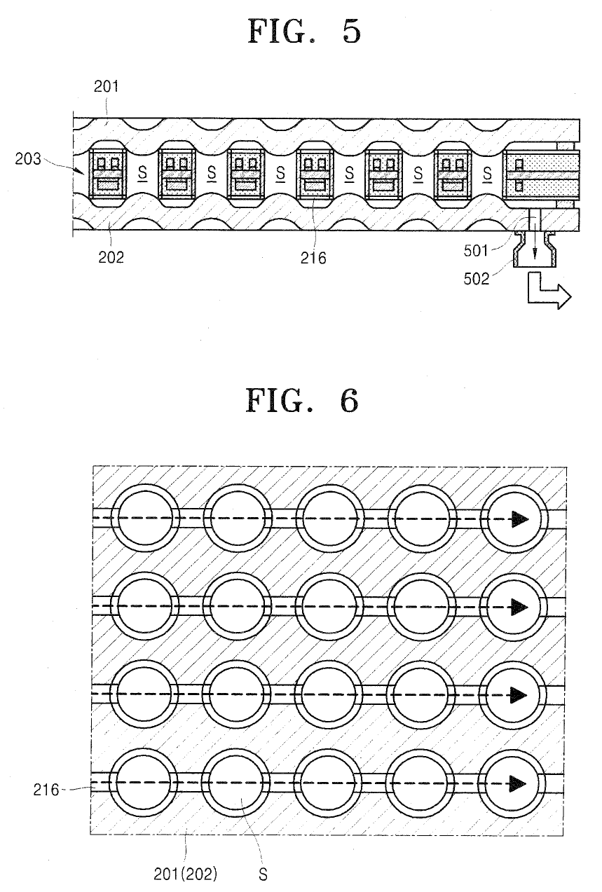

Referring to FIGS. 2, 3 and 4, a PDP 200 includes a first substrate 201 and a second substrate 202 that faces the first substrate 201. The first and second substrates 201, 202 are formed of a flexible film such as a polymer resin having high optical transmittance. Thus, the first and second substrates 201, 202 can be folded and rolled. Alternatively, the first and second substrates 201, 202 can be colored or semi-transparent in order to increase bright room contrast by reducing reflection brightness.

A discharge electrode sheet 203 is interposed between the first and second substrates 201, 202. The discharge electrode sheet 203 includes a base film 204, a plurality of discharge electrode pairs 205 patterned on and below the base film 204, and a dielectric layer 206 that buries the discharge electrode pairs 205. Also, a plurality of opening holes 214 are formed in portions of the discharge electrode sheet 203 corresponding to discharge cells S.

Each of the discharge electrode pairs 205 includes a first discharge electrode 207 and a second discharge electrode 208. One first discharge electrode 207 and one second discharge electrode 208 are disposed in each of the discharge cells S. The first discharge electrode 207 is disposed relatively closer to the first substrate 201, and the second discharge electrode 208 is disposed relatively closer to the second substrate 202.

The first discharge electrode 207 surrounds the discharge cells S adjacently disposed along an X direction of the PDP 200. The first discharge electrode 207 includes first loop units 207a that surround the discharge cells S and first bridge units 207b that electrically connect the adjacent first loop units 207a.

The first loop unit 207a has a closed loop circular shape. However, the shape of the first loop unit 207a is not limited thereto, and can be various shapes, for example, a closed loop of other shapes such as a rectangular shape or a hexagonal shape, or an open loop as long as the first loop unit 207a has a structure that surround the discharge cell S.

The second discharge electrode 208 surrounds the discharge cells S adjacently disposed along a Y direction of the PDP 200, which is a direction crossing the first discharge electrode 207 of the PDP 200. The second discharge electrode 208 is separated from the first discharge electrode 207 in a Z direction of the PDP 200 in the discharge electrode sheet 203.

The second discharge electrode 208 includes second loop units 208a, each surrounding the discharge cell S, and second bridge units 208b that electrically connect adjacent second loop units 208a. The second loop unit 208a has a closed loop of circular shape, however, can have any shape as long as the second loop unit 208a has a structure surrounding the discharge cell S.

In the PDP 200 having a two-electrode structure with first and second discharge electrodes 207, 208 one of the first discharge electrode 207 and the second discharge electrode 208 functions as a scanning and sustaining electrode, and the other electrode functions as an addressing and sustaining electrode.

Alternatively, the PDP 200 can include a three-electrode structure in which the first and second discharge electrodes 207, 208 are disposed in the same direction to function as a pair of discharge sustain electrodes, and an address electrode is further included in a direction crossing the first and second discharge electrodes 207, 208, however, the structure of the PDP 200 is not limited thereto.

The first and second discharge electrodes 207, 208 are disposed in opposite directions from surfaces of the base film 204. That is, the first discharge electrode 207 is patterned closer towards the first substrate 201 from a first surface of the base film 204, and the second discharge electrode 208 is patterned closer towards the second substrate 202 from a second surface of the base film 204.

The first discharge electrode 207 has a two-layer structure in which a first metal film layer 209 formed on a first surface of the base film 204 and a first plating layer 210 formed on the first metal film layer 209 are stacked. The second discharge electrode 208 also has a two-layer structure in which a second metal film layer 211 formed on the second surface of the base film 204 and a second plating layer 212 formed on the second metal film layer 211 are stacked.

The base film 204 is formed of a polymer resin such as polyimide. The first metal film layer 209 and the second metal film layer 211 are formed of a metal film layer having high electrical conductivity such as a copper foil which is directly attached to the base film 204. The first plating layer 210 and the second plating layer 212 are plating layers formed on surfaces of the first metal film layer 209 and the second metal film layer 211. They are formed of a copper plating layers in the present embodiment, but are not limited thereto.

As described above, the first and second discharge electrodes 207, 208 are respectively patterned on both surfaces of the base film 204, and have a two-layer structure in which the first plating layer 210 and the second plating layer 212 are coated on the first metal film layer 209 and the second metal film layer 211. The first and second discharge electrodes 207, 208 are not disposed in positions that directly reduce the transmittance of visible light like inner surface of the first and second substrates 201, 202, and thus, can be formed of a metal having high electrical conductivity such as copper or aluminum.

The first and second discharge electrodes 207, 208 are buried in the dielectric layer 206. The dielectric layer 206 may be formed of a dielectric material that can prevent the first and second discharge electrodes 207, 208 from being directly electrically connected and from being damaged by protons and electrons, and thus can facilitate the accumulation of wall charges by inducing charges.

The discharge electrode sheet 203 is formed to configure the discharge cells S to have a circular shape horizontal cross-section. However, the present invention is not limited to a circular shape horizontal cross-section. That is, the discharge electrode sheet 203 can be formed to configure the opening holes 214 so that the opening holes 214 can define the discharge cells S as having any horizontal cross-section shape, for example, a polygonal shape, a circular shape, or a non-circular shape. The opening holes 214 can be formed to define the discharge cells S as having a delta form, a waffle form, or a meander form.

A protection film layer 213 is formed on an inner wall of the discharge electrode sheet 203 that contacts the discharge cells S. The protection film layer 213 prevents the first and second discharge electrodes 207, 208 from being damaged by sputtering of plasma particles, and simultaneously functions to reduce a discharge voltage by emitting secondary electrons. The protection film layer 213 can be formed of MgO.

Also, a phosphor layer groove 201a having a predetermined depth is formed in an inner surface of the first substrate 201 corresponding to each of the discharge cells S. The phosphor layer groove 201a is formed in each of the discharge cells S, and has a shape substantially identical to the shape of the discharge cell S.

A red, green, or blue phosphor layer 215 is coated in respective phosphor layer grooves 201a. Alternatively, the red, green, and blue phosphor layers 215 can be formed on an inner surface of the second substrate 202 and on inner wall of the discharge electrode sheet 203 that contacts the discharge cells S. That is, as long as the phosphor layers 215 are coated within their respective discharge cells S, the coating of the phosphor layers 215 is not limited to any one location.

The phosphor layers 215 include components that generate visible light by receiving ultraviolet rays. A phosphor layer formed in the red light emitting cell would have a red light phosphor such as Y(V,P)O₄:Eu. A phosphor layer formed in the green light emitting cell would have a green light phosphor such as Zn₂SiO₄:Mn or YBO₃:Tb, A phosphor layer formed in the blue light emitting cell would have a blue light phosphor such as BAM:Eu.

A discharge gas such as Ne gas, Xe gas, or a gas mixture of Ne and Xe is filled in the discharge cells S. In the present embodiment, the PDP 200 can be driven at a low voltage since the amount of plasma is increased due to the increased discharge surface and increased discharge area. Thus, even though a high concentration of Xe gas is used as the discharge gas, a low driving is possible, thereby greatly increasing luminous efficiency.

An exhaust gas pathway 216 that passes between the adjacent discharge cells S is formed in the discharge electrode sheet 203. That is, predetermined grooves are formed in the dielectric layer 206 in a depth direction of the dielectric layer 206 from a surface of the dielectric layer 206, and the grooves are connected to the adjacent discharge cells S, and thus, each exhaust gas pathway 216 is formed in the discharge electrode sheet 203. Each exhaust gas pathway 216 corresponds to the surface of the dielectric layer 206 that contacts the first and second substrates 201, 202.

The exhaust gas pathways 216 are formed on regions of the dielectric layer 206 between the discharge cells S adjacently disposed in the X direction of the PDP 200, and have stripe shaped grooves formed by reducing the thickness of the dielectric layer 206 smaller than other regions so that the grooves can connect the adjacent discharge cells S to each other. Thus, the discharge cells S adjacently disposed in the X direction of the PDP 200 are connected to each other by an exhaust gas pathway 216.

The PDP 200 having the above configuration is driven in the following manner.

First, an addressing discharge is generated between the first and second discharge electrodes 207, 208, and discharge cells S to be discharged are selected as a result of the addressing discharge. Afterwards, a sustain discharge voltage is applied to the first and second discharge electrodes 207, 208 in the selected discharge cells S and a sustain discharge is generated between the first and second discharge electrodes 207, 208.

Due to the sustain discharge, the discharge gas is excited, and ultraviolet (UV) rays are generated while the energy level of the discharge gas is reduced. The UV rays excite the phosphor layers 215, and thus, visible light is emitted from the phosphor layers 215 while the energy level of the phosphor layers 215 is reduced. The visible light forms an image.

A method of forming the PDP 200 driven as described above includes a process of forming the first substrate 201, a process of forming the second substrate 202, and a process of forming the discharge electrode sheet 203.

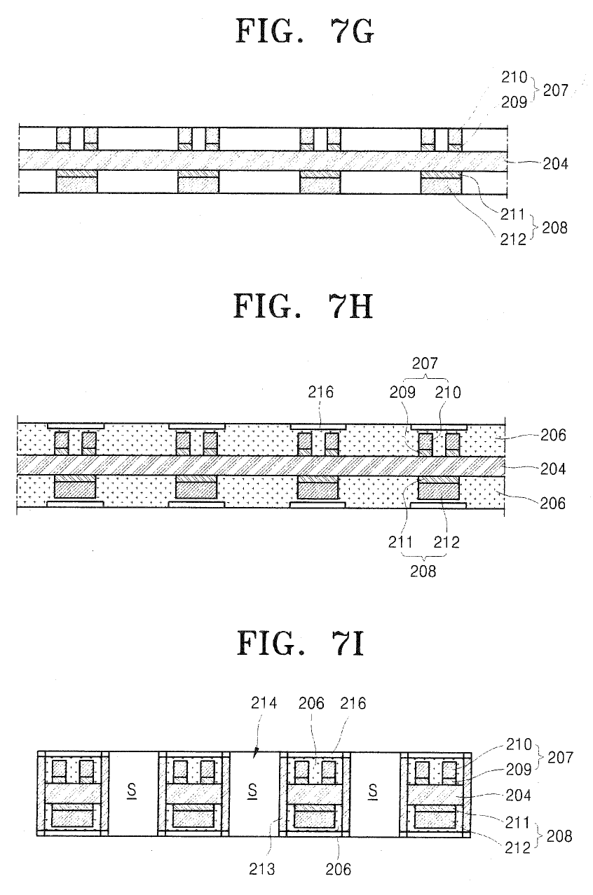

In order to form the phosphor layers 215 on the first substrate 201, the phosphor layer grooves 201a having a predetermined depth are formed in regions of the first substrate 201 corresponding to the discharge cells S from the surface of the first substrate 201, and the phosphor layers 215 are formed in the phosphor layer grooves 201a. The process of forming a pattern layer in the discharge electrode sheet 203 will be described with reference to FIGS. 7A through 7I

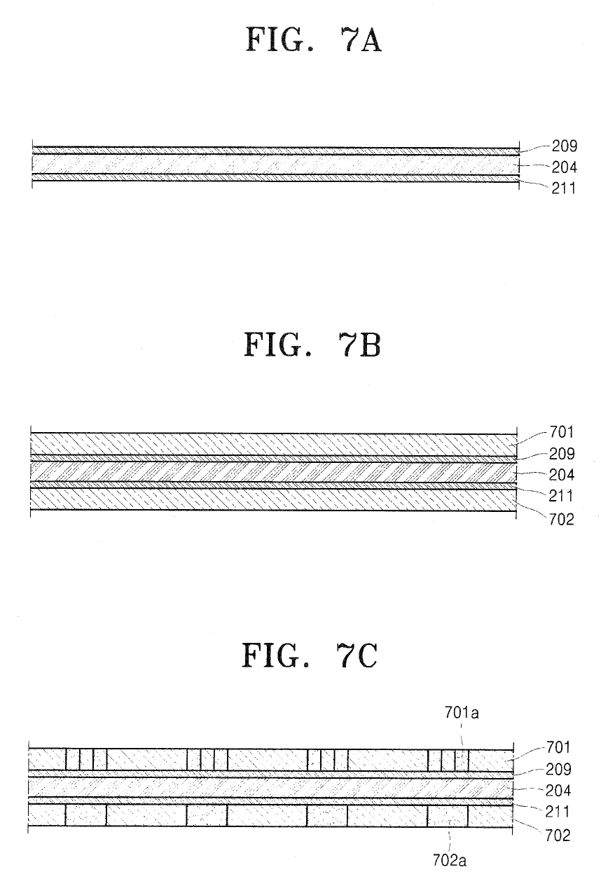

The discharge electrode sheet 203 is disposed between the first substrate 201 and the second substrate 202 which are respectively prepared, and a sealing process is performed using a frit glass (not shown). Afterwards, as depicted in FIG. 5, an exhaust tube 502 is attached to an external surface of the second substrate 202, and the exhaust tube 502 is aligned with an exhaust hole 501. Then, the PDP 200 is manufactured by consecutively performing a vacuuming process and a process of injecting a discharge gas. Various subsequent processes can be performed after the vacuuming process and the discharge gas injection process.

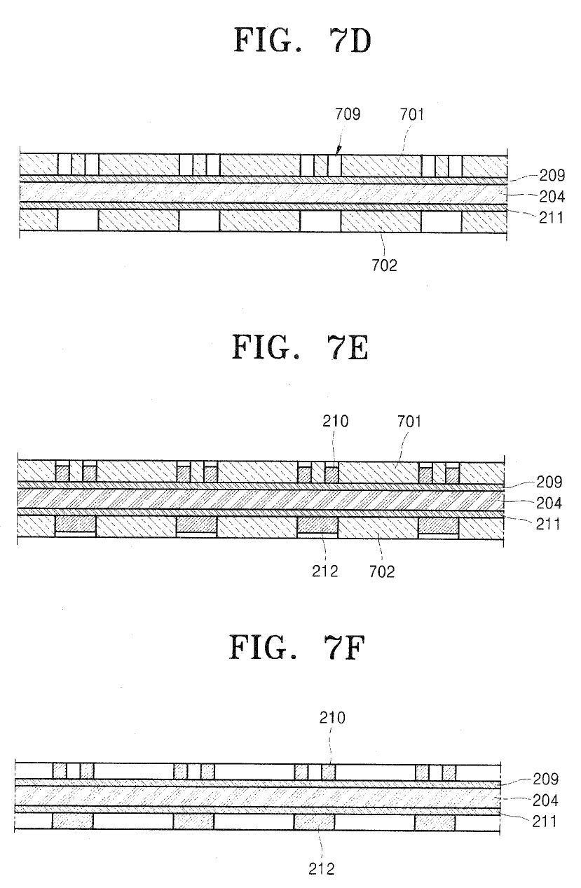

Referring now to FIG. 6, the exhaust gas pathway 216 that connects the adjacent discharge cells S and is formed by differentiating the thickness of the dielectric layer 206, is formed on upper surface and lower surface of the discharge electrode sheet 203 that contacts the first and second substrates 201, 202. Thus, an impurity gas that contains moisture remaining in the discharge cells S can be readily exhausted through the exhaust gas pathway 216 as indicated by the arrows.

A method of manufacturing the discharge electrode sheet 203 will now be described referring to FIGS. 7A through 7I

Referring first to FIG. 7A, a base film 204 formed of polymer resin is prepared. In order to prepare a raw material for forming the discharge electrode sheet 203, a first metal film layer 209 is attached to a first surface of the base film 204, and a second metal film layer 211 is attached to a second surface of the base film 204.

Referring to FIG. 7B, a first photoresist 701 is coated on a surface of the first metal film layer 209, and a second photoresist 702 is coated on a surface of the second metal film layer 211.

Next, a photomask is installed on the base film 204, and, as depicted in FIG. 7C, portions of the patterned first photoresist 701a and the patterned second photoresist 702a where a discharge electrode pattern is to be formed are exposed.

Next, referring to FIG. 7D, plating holes 709 having a discharge electrode pattern are formed by developing the patterned first photoresist 701a and the patterned second photoresist 702a.

Referring to FIG. 7E, after forming the plating holes 709, a first plating layer 210 and a second plating layer 212 are respectively plated through the plating holes 709 on first and second surfaces of the base film 204 through a plating process. Thus, the first metal film layer 209 and the first plating layer 210 are electrically connected, and the second metal film layer 211 and the second plating layer 212 are electrically connected.

After the plating of the first and second plating layers 210, 212 is completed, as depicted in FIG. 7F, the first plating layer 210 and the second plating layer 212 are patterned by removing the first photoresist 701 and the second photoresist 702.

Next, referring to FIG. 7G, the first and second discharge electrodes 207, 208 are patterned by etching the first metal film layer 209 and the second metal film layer 211 except for the region where the first metal film layer 209 and the first plating layer 210 are stacked and the region where the second metal film layer 211 and the second plating layer 212 are stacked.

As a result, the first discharge electrode 207 has a two-layer structure including the first metal film layer 209 and the first plating layer 210 plated on the first metal film layer 209, and the second discharge electrode 208 has a two-layer structure including the second metal film layer 211 and the second plating layer 212 plated on the second metal film layer 211.

Referring to FIG. 7H, a dielectric layer 206 that buries the first and second discharge electrodes 207, 208 is coated on the base film 204. At this point, exhaust gas pathways 216 are formed by forming grooves having a predetermined depth in the surface of the dielectric layer 206. An exhaust gas pathway 216 is formed by reducing the thickness of regions of the dielectric layer 206 between discharge cells S, which will be formed in a subsequent process, to be smaller than the thickness of other regions of the dielectric layer 206.

Referring to FIG. 7I, after forming the dielectric layer 206 having the exhaust gas pathways 216, the discharge cells S are formed by forming a plurality of opening holes 214. At this point, the first and second discharge electrodes 207, 208 are patterned to surround the discharge cells S. Alternatively, after forming the opening holes 214, the dielectric layer 206 for forming the exhaust gas pathway 216 can be coated by burying the first and second discharge electrodes 207, 208.

A protection film layer 213 is formed on an inner wall of the discharge electrode sheet 203 that contacts the discharge cells S. Thus, the manufacture of the discharge electrode sheet 203 is completed.

In a PDP according to the present invention and a method of manufacturing a discharge electrode sheet used in the PDP, an exhaust gas pathway that connects adjacent discharge cells is formed in a film shape discharge electrode sheet disposed between flexible substrates. Thus, when the discharge cells are vacuumed, impurity gases containing moisture can be smoothly exhausted through the exhaust gas pathway. Accordingly, pulling of the substrates in the discharge electrode sheet can be prevented.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A plasma display panel comprising:
a first substrate and a second substrate, the first substrate and the second substrate being flexible and facing each other;
a discharge electrode sheet between the first substrate and the second substrate, the discharge electrode sheet having a plurality of discharge cells and a plurality of patterned discharge electrodes for discharging the discharge cells;
a phosphor layer in each of the discharge cells; and
a plurality of exhaust gas pathways in the discharge electrode sheet, each exhaust gas pathway connecting a one of the plurality of discharge cells with an adjacent discharge cell.

2. The plasma display panel of claim 1, wherein the first substrate or the second substrate is a film formed of a polymer.

3. The plasma display panel of claim 1, wherein each of the discharge electrodes comprise:
a first discharge electrode in a first direction of the plasma display panel, and
a second discharge electrode in second direction crossing the first direction.

4. The plasma display panel of claim 3, wherein the first discharge electrode and the second discharge electrode extend in different directions from each other and surround a circumference of the discharge cell.

5. The plasma display panel of claim 1, wherein the discharge electrode sheet further comprises:
a base film, and
a dielectric layer burying the discharge electrodes,
wherein the patterned discharge electrodes are on the base film, and
wherein opening holes are through the discharge electrode sheet in portions of the discharge electrode sheet corresponding to the discharge cells.

6. The plasma display panel of claim 5, wherein the base film is a polymer resin.

7. The plasma display panel of claim 5, wherein the patterned discharged electrodes include:
a first patterned discharge electrode patterned on a surface of the base film, and
a second patterned discharge electrode patterned on a second surface of the base film.

8. The plasma display panel of claim 7, wherein each of the first patterned discharge electrodes and the second patterned discharge electrodes comprises a metal film layer and a plating layer formed on the metal film layer formed on the base film.

9. The plasma display panel of claim 1, wherein:
each exhaust gas pathway comprises a groove in a surface of the dielectric layer contacting the first substrate or the second substrate, and
adjacent discharge cells are connected by the groove.

10. The plasma display panel of claim 9, wherein each groove is between the discharge cells adjacent in a direction of the plasma display panel and the adjacent discharge cells are connected by a reduced thickness of regions of the dielectric layer between the discharge cells smaller than other regions of the dielectric layer.

11. The plasma display panel of claim 5, further comprising a protection film layer on an inner wall of the discharge electrode sheet contacting the discharge cells.

12. The plasma display panel of claim 1, wherein phosphor layer grooves having a depth are in an inner surface of regions of the first substrate or the second substrate corresponding to each of the discharge cells, and the phosphor layer is in each of the phosphor layer grooves.

13. A method of manufacturing a discharge electrode sheet, comprising:
preparing a raw material for forming the discharge electrode sheet;
forming plating holes having a discharge electrode pattern by exposing and developing a photoresist after coating the photoresist on the raw material for forming the discharge electrode sheet;
plating a plating layer in the plating holes;
removing the photoresist;
forming a discharge electrode pattern by etching the plating layer;
forming an exhaust gas pathway by coating a dielectric layer on the raw material for forming the discharge electrode sheet to bury the discharge electrodes; and
forming opening holes corresponding to the discharge cells in the raw material for forming the discharge electrode sheet.

14. The method of claim 13, wherein the preparing of a raw material for forming the discharge electrode sheet comprises preparing a base film and attaching metal film layers onto both surfaces of the base film.

15. The method of claim 14, wherein the forming of the plating holes having a discharge electrode pattern comprises forming a photoresist pattern on regions corresponding to the metal film layers formed on the base film.

16. The method of claim 14, wherein the plating of the plating layer comprises plating a plating layer electrically connecting the metal film layer through the plating holes.

17. The method of claim 16, wherein the etching of the plating layer comprises forming a discharge electrode pattern by etching the metal film layer except for the regions where the metal film layer and the plating layer are stacked.

18. The method of claim 14, wherein the forming of the exhaust gas pathway comprises connecting the adjacent discharge cells with the grooves after forming the grooves by reducing the thickness of the dielectric layer between adjacent discharge cells.

19. The method of claim 14, further comprising forming a protection film layer on an inner wall of the discharge electrode sheet contacting the opening holes.
